(19) United States
(12) Patent Application Publication
(10) Pub. No.: US 2003/0023621 A1
(43) Pub. Date: Jan. 30, 2003

(54) Remote activated internet file transfer and storage device

(76) Inventor: Jay Muse, Centerville, UT (US)

Correspondence Address: CESARI AND MCKENNA, LLP, 88 BLACK FALCON AVENUE, BOSTON, MA, 02210, US

(21) Appl. No.: 09/912,821

(22) Filed: Jul. 25, 2001

(51) Int. Cl. G06F 12/00

(52) U.S. Cl. 707/204

(57) ABSTRACT

A system and devices for transferring and storing digital files from a local host to a remote host using a PSTN network to communicate at a time predetermined and preset by the recipient. A local device accepts data files from a local host, stores them until a predetermined and preset time and then uses a modem to contact a remote device. Once the local device has contact the remote device, the data files are transferred to the remote device. A remote host, connected to the remote device, can then access the data files from the remote device.

### FIELD OF THE INVENTION

The present invention relates to the delivery of digital files over a communications network and, in particular, to the automatic delivery of personal digital files to a recipient over a PSTN network.

### BACKGROUND OF THE INVENTION

In today's digital age, many people have a desire to share digital files with others. This sharing can be accomplished in several ways. One of the most common methods is to send the files to be shared as an attachment to an electronic mail message addressed to the intended recipient. A second method is to copy the files to be shared onto some portable storage medium, for example, a floppy diskette, and to physically transfer the storage medium to the recipient. A third method is to remotely mount a drive on the recipient's computer and then simply copy the files to the recipient's hard drive.

Each of these options has drawbacks, such as the need for physical proximity and access to the recipient in the case of using storage media or the need to be rather computer literate and have access to some established network in the other two examples.

Additionally, many personal consumer electronic devices can now utilize digital files. For example, the Fotoshow™ device from Iomega Corporation, of Roy, Utah, can display digital pictures on a standard television set. Currently, the only way to move a file to a device like Fotoshow is to copy the files to some form of removable storage media (e.g. Zip disk, Flash card) and physically transfer the storage media to the recipient's device.

There is needed an inexpensive and technically easy way to transfer digital files from one host to another. The present invention is directed to a system and device for transferring digital files from a local host to a remote host without the need for either physical proximity or the need for the users to be very computer literate.

### SUMMARY OF THE INVENTION

The present invention is directed to a system and device for transferring and storing files to a remote recipient using a modem connection over a phone line. According to the invention, the sender chooses which files to send and the local device receives and stores the files until a predetermined and preset time. At the predetermined time, the local device uses its modem to call the remote device and to transfer the files.

When a device is in receiving mode, the device waits until the preset time and then begins answering the phone line attached to its modem. After verifying that the caller is an appropriate device, it will receive and store the files. The remote host can then access and remove the files from the remote device at a later time. In alternate embodiments of the invention, the device is integrated into other devices, such as a Fotoshow unit.

### BRIEF DESCRIPTION OF THE DRAWINGS

The invention description below refers to the accompanying drawings, of which:

FIG. 1 is a block schematic diagram of a system for remotely transferring and storing files;

FIG. 2 is a block schematic diagram of a file transfer and storage device (FTSD);

FIG. 3 is a flowchart of the operation of a FTSD when it is in transmit mode;

FIG. 4 is a flowchart of the operation of a FTSD when it is in receive mode; and

FIG. 5 is a block schematic diagram of a FTSD integrated into another device.

### DETAILED DESCRIPTION OF AN ILLUSTRATIVE EMBODIMENT

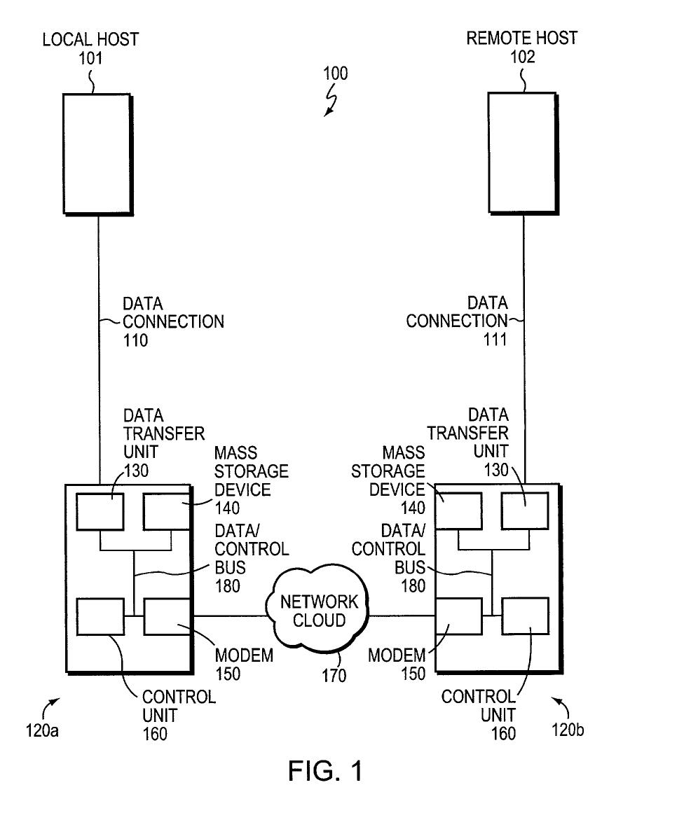

FIG. 1 is a schematic block diagram of a system 100 for remotely transferring and storing files. The system 100 comprises a local host 101 connected to a first file transfer and storage device (FTSD) 120a by a data connection 110, a remote host 102 connected to a second FTSD 120b by a data connection 111, and a telephone (PSTN) network 170 interconnecting FTSD 120a and FTSD 120b.

The local host 101 and remote host 102 can be any type of device that can utilize digital files, e.g. personal computers, personal digital assistants, consumer electronics, or digital imaging devices such as a Fotoshow unit.

Data connections 110 and 111 can be any type of two-way communication protocols, including, as illustrative examples, serial cables (RS-232/422/423), universal serial bus (USB), Firewire, infrared, radio frequency (IEEE 802.11), or Ethernet connections. Data connections 110 and 111 do not need to be of the same type of protocol, for example data connection 110 could be USB while data connection 111 is a RF protocol.

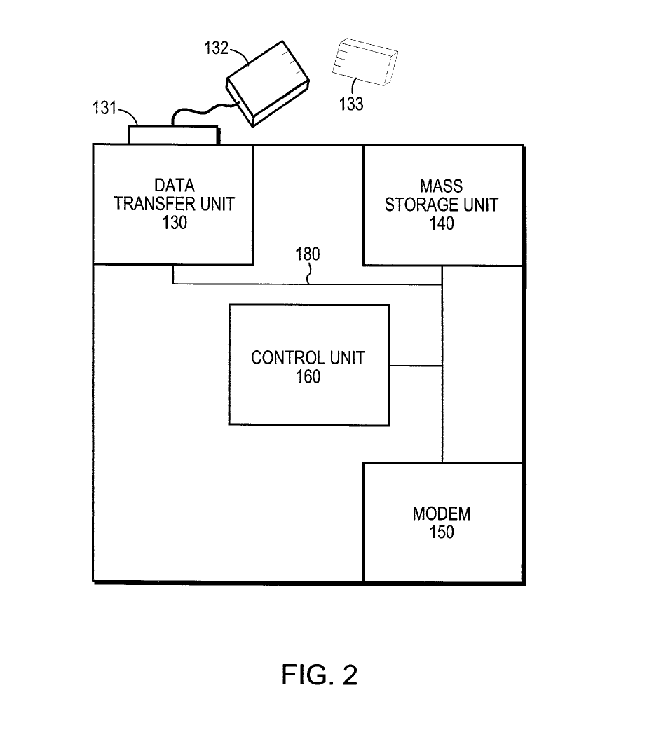

FIG. 2 shows a block diagram of a FTSD 120. The FTSD 120 comprises a data transfer unit 130, a mass storage unit 140, a modem 150, and a control unit 160 all connected to a bus 180. The data transfer unit 130 communicates to the host via a data connection. The data transfer unit can communicate using one or more methods of data transfer protocols that can be used to communicate with the host, e.g. USB, firewire, Ethernet, etc.

The mass storage device 140, can be any type of digital mass storage, e.g. a hard drive, a Zip disk drive, or Flash RAM. The modem 150 is a standard modem as is well known by those skilled in the art. The modem 150 can operate at any speed.

Control unit 160, can be a microcontroller, a microprocessor or similar device that is programmed to operate the FTSD in accordance with the described method of operation.

In an alternative embodiment the data transfer unit 130 comprises a universal serial bus (USB) connector 131. USB connector 131 could be connected to a memory card reader 132 to enable the FTSD to receive files from a memory card 133. The memory card 133 could be any form of removable memory, including as illustrative examples, a flash RAM card or a memory stick

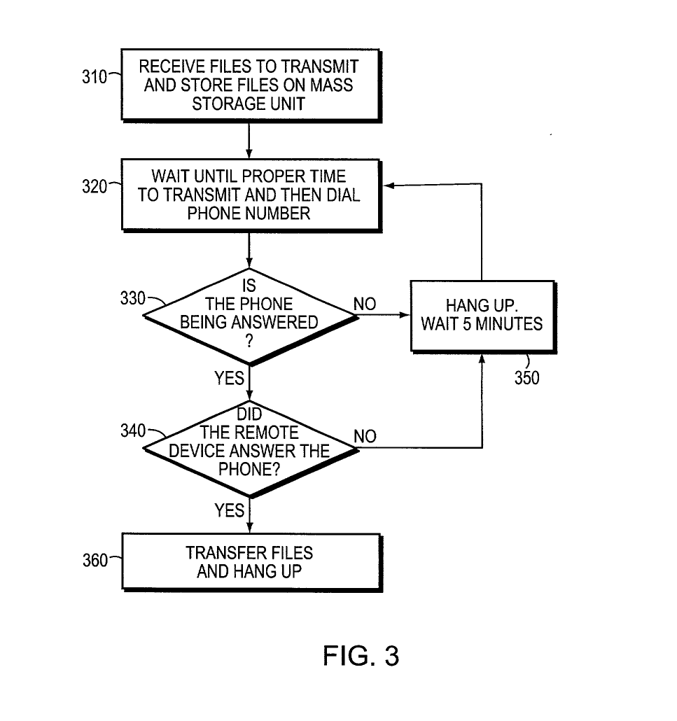

FIG. 3 is a flow chart of the operation of the system when a user on the local host transfers one or more files to a remote FTSD. When a user on the local host decides that he wants to share a file with the recipient on the remote host, he will cause the files to be sent to the FTSD via the data connection. In block 310, the FTSD stores the files on its mass storage unit. The in block 320, the first FTSD will wait until the time is within a preset window, at which point it will activate its internal modem and call the remote FTSD.

In an illustrative embodiment, a FTSD will use a time period from 2:00AM to 2:30AM as the preset window. A user can change the preset window to another time period. For example, a user could select 6:40-7:00AM as the preset calling window. The preset time window is set by the user via a graphical user interface prompt given by the control unit in both the local and remote FTSDs. It should be noted that the preset window of time can be of any length duration and at any time. If the remote device is contacted by a local device during a time not within the preset window, the remote FTSD will not answer the phone line.

In a preferred embodiment, the phone number of the remote device is entered into the local device by a user via graphical user interface prompt provided by the control unit. A FTSD can have multiple numbers, each selected for a different time slot. For example, a FTSD can be programmed to transfer files X and Y during the 2:00-2:30AM time period via a connection to phone number Z. The same FTSD can also be programmed to transfer files A, B and X during the 3:00-3:45AM time window via a connection to phone number C.

The second FTSD will answer the phone before the first ring, block 330, and then in block 340, verify that a FTSD is calling using technology similar to that employed by fax machines.

After the connection is made between the two FTSDs, the first FTSD transfers the files to the second FTSD in block 360. After the files are transferred, the first FTSD will erase the files from its mass storage unit.

If the call is not answered, then in block 350, the modem will hang up and the control unit will wait some period of time before verifying that the appropriate time window is still open and then redialing.

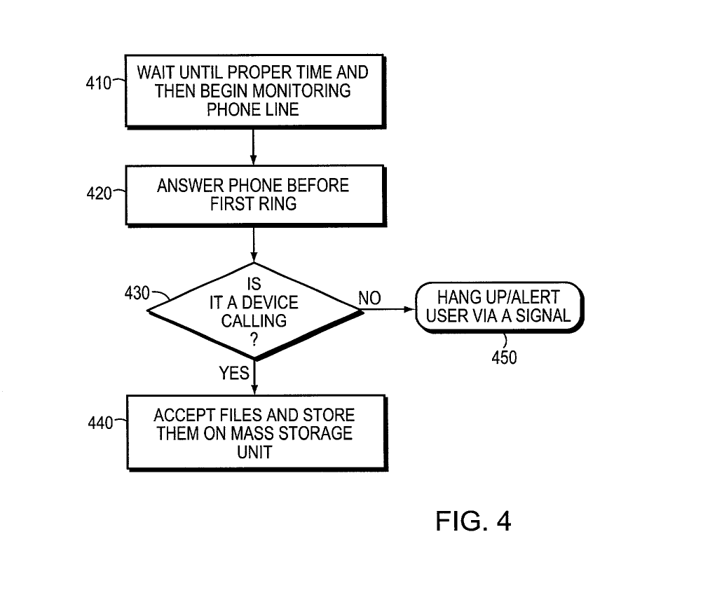

FIG. 4 is a flow chart of the operation of a FTSD when it is receiving files. The control unit will keep the FTSD idle until the time is within a preset window when it will accept incoming files in block 410. Once the time window has begun, the modem will monitor the phone line and answer any incoming call before the first ring as in block 410. Once the call is answered the modem will verify in block 430 that the caller is a FTSD using technology similar to that used in fax machines. If the caller is not a FTSD, in block 440, the modem will either hang up the line or in an alternate embodiment, issue a warning signal to the user that a phone call is incoming. The warning signal can be an audible or visual sound emanating from the FTSD. In another preferred embodiment, a message is transmitted to the host connected to the FTSD.

If the caller is a FTSD, the modem will receive the files and the control unit will have the files stored on the mass storage device in block 450. Once the transfer is complete the modem will hang up the phone and, if the time window for receiving incoming files is still open, resume monitoring the phone line.

The modems in the FTSDs utilize normal error correction techniques to prevent files from being corrupted during transfer.

It should be noted that the remote FTSD does not need to be attached to a host for it to receive files. After files have been received, a host can be attached later to retrieve the stored files. Additionally, after the local host transmits the files to the FTSD, the local host can be either powered down or disconnected from the FTSD. Also, the modem 150 does not need to be directly connected to a phone line. In an illustrative embodiment, the modem is connected to a VoIP unit.

In this alternate embodiment, the local and/or the remote FTSD must be connected to a Voice over IP unit. An illustrative VOIP unit would be the VoIP Blaster from Creative Labs of Milpitas, Calif. If a VoIP unit is utilized, the host connected to tha FTSD using the VoIP must be powered on for the transfer to work.

In an alternative embodiment of the invention, the FTSD be built onto a PCB card that could then be installed within a personal computer. In this embodiment, the host (i.e. the personal computer) would need to be powered on for the FTSD to receive files. The card could be built to any number of standard specifications Illustrative examples of these standards include PCI, ISA, EISA, VESA, 64-bit PCI, Fibre Channel, or AGP.

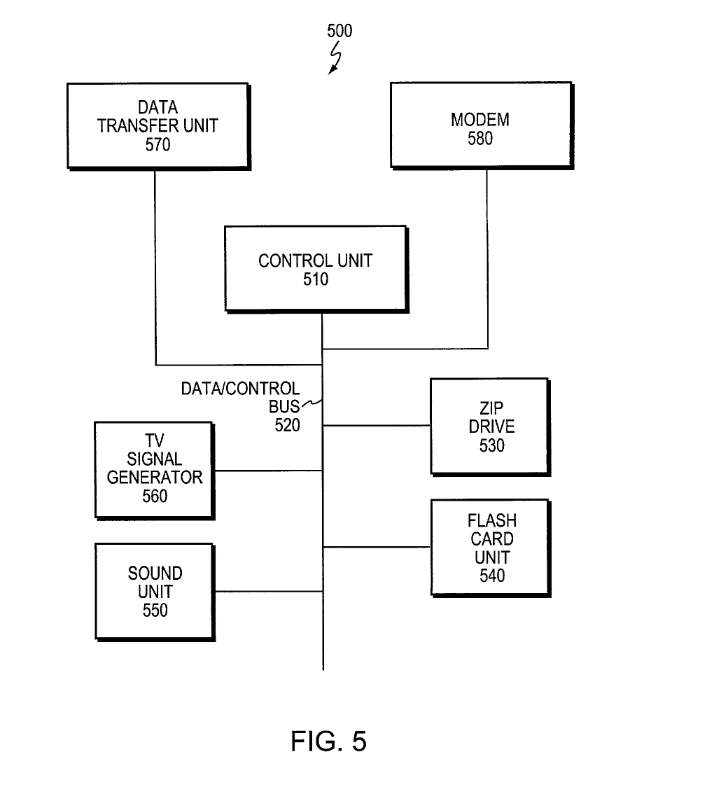

Another alternative embodiment of the invention is the integration of the FTSD into another device, e.g. a Fotoshow unit. FIG. 5 shows a block diagram of an illustrative example of this alternative embodiment. In this alternative embodiment, the integrated system 500 comprises a control unit 510, a Zip drive 530, a flash card reader 540, a sound generation unit 550, a TV signal generator 560, a data transfer unit 570 and a modem 580, all of which are connected to a data and control bus 520.

The Zip drive 530 can be any type of Zip compatible drive. The flash card unit 540 is a standard flash card reader and writer.

The data transfer unit 570 is equivalent to the data transfer unit 130 already described.

To transfer files in a normal Fotoshow device, the user must copy the files to either a Zip disk or a flash card and physically give them to the recipient. Using an integrated FTSD and Fotoshow unit, the sender can have his FTSD automatically transfer the files to the recipient. The recipient would need to have a Zip disk in the Zip drive or a flash card in the flash card unit to be able to store the image or sound files. In an integrated unit, the control unit that is normally present in the device is modified to include appropriate logic and controls to implement the FTSD.

In summary, the invention is directed to a device configured for the remote transfer and storage of files over a communications network. The present invention can be either a standalone unit or integrated into another device to incorporate the features of the present invention into that device.

The foregoing description has been directed to several specific embodiments of this invention. It will be apparent, however, that other variations and modifications may be made to directed embodiments, with the attainment of some or all of their advantages. Therefore, it is the object of the appended claims to cover all such variations and modifications as come within the true spirit and scope of the invention.

What is claimed is:

1. A system for transferring files to a remote host comprising:
a local device;
a remote device;
a communications network;
the local device programmed to perform the steps of:
A) store a plurality of files on a first mass storage unit;
B) wait until a preset time;
C) connect to the remote device after the preset time, the connection made through the communications network; and
D) transfer the plurality of files to the remote device via the communications network;
the remote device programmed to perform the steps of:
E) wait until the preset time;
F) accept, in response to the communications network not being used and in response to the preset time, a connection request from the local device via the communications network;
G) receive the plurality of files in response to a grant of the connection request, the files received through the communications network from the local device;
H) store the plurality of files on a second mass storage unit; and
I) when ordered to by the remote host, transfer the plurality of files from the second mass storage unit to the remote host.

2. The system of claim 1, further comprising
a universal serial bus (USB) connector, the USB connector connected to the local device such that the local device can receive files via the USB connector.

3. The system of claim 1, further comprising:
a local host, the local host transmitting the plurality of files to the local device.

4. The system of claim 1, further comprising:
means for issuing a warning signal in response to both the communications network being used and in response to the preset time.

5. A system as in claim 4 wherein the warning signal further comprises:
an audible sound.

6. A system as in claim 4 wherein the warning signal further comprises:
a message transmitted to the remote host.

7. A system as in claim 1 wherein the communications network further comprises:
a public switched telephone network.

8. A device for transferring and storing files comprising:
a data transfer unit, said data transfer unit capable of communicating with a host via a plurality of data transfer protocols;
a plurality of mass storage units;
a modem connected to a phone line; and
a control unit;
the control unit is programmed to have the device perform the steps of:
A) receive a plurality of files from a local host via the data transfer unit;
B) store the plurality of files on the plurality of mass storage units;
C) wait until a time frame set by the remote device;
D) connect to a remote device via the modem; and
E) transfer the plurality of files to the remote device.

9. A device for transferring and storing files comprising:
a data transfer unit, said data transfer unit capable of communicating with a host via a plurality of data transfer protocols;
a plurality of mass storage units;
a modem connected to a phone line; and
a control unit;
the control unit is programmed to have the device perform the steps of:
A) wait until a preset time;
B) accept connection requests from the modem;
C) receive, in response to a grant of the connection request, a plurality of files via the modem;
D) store the plurality of files on the plurality of mass storage units.

10. A method for transferring a plurality of files to a remote host comprising the steps of:
A) storing the plurality of files on a first mass storage unit;
B) waiting until a preset time, the preset time being determined by the remote host of the files;
C) connecting to a remote device after the preset time, the connection occurring via a communications network;
D) transferring the plurality of files to a remote device via the communications network.

11. A method for receiving a plurality of files comprising the steps of:
A) waiting until a preset time;
B) accepting, after the preset time, a connection request from a local device via a communications network;
C) receiving the plurality of files, in response to a grant of the connection request, from the local device;
D) storing the plurality of files on a mass storage device;
E) transferring the plurality of files to a remote host, the transfer occurring when requested by the remote host.
